(19) United States
(12) Patent Application Publication
(10) Pub. No.: US 2008/0059783 A1
(43) Pub. Date: Mar. 6, 2008

(54) MULTIMEDIA PLAYER AND AUTO RECOVERY METHOD THEREFOR

(75) Inventors: Chen Cheng Chiang, Taichung City (TW); Tson Yee Lin, Taipei City (TW); Chang Hung Lee, Yunlin (TW)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/843,594

(22) Filed: Aug. 22, 2007

(30) Foreign Application Priority Data
Sep. 1, 2006 (TW) TW95132345

(51) Int. Cl. G06F 9/00

(52) U.S. Cl. 713/1

(57) ABSTRACT

An auto recovery method for a multimedia player is disclosed. A microcontroller is initialized and a central processing unit (CPU) is activated. It is determined whether a power-off request from the CPU is received. If not, it is determined whether a monitor message from a monitor application is periodically received. If no monitor messages are received within a predetermined period of time, the CPU is disconnected and then reactivated.

### BACKGROUND OF THE INVENTION

1. Field of the Invention

The invention relates to a multimedia player, and more particularly to an auto recovery method for a multimedia player.

2. Description of the Related Art

Currently, when system errors occur in the playback of a multimedia disc, such as a Digital Versatile Disc (DVD), the multimedia player must be powered off and then on again before for normal operation can resume.

FIG. 1 is a schematic view of a multimedia player. The multimedia player comprises a central processing unit (CPU) 110, a microcontroller 120, a vacuum fluorescent display (VFD) 130, a real-time clock (RTC) 140, and a power 150. Power 150 applies power to the multimedia player and hardware components therein.

When the multimedia player is powered on, microcontroller 120 is first activated to control the multimedia player. Central processing unit 110 is then activated and the management authority of the multimedia player is then transferred to central processing unit 110. When VFD 130, located at a front panel, receives an operational request, to, for example, trigger a button on the front panel or on a remote control (not shown), the request is then transmitted to central processing unit 110. When the multimedia player enters a standby mode, central processing unit 110 sends an interrupt request (IRQ) to microcontroller 120. Next, microcontroller 120 disconnects central processing unit 110 and the management authority of the multimedia player is then transferred to microcontroller 120 at which time, operational commands from VFD 130 are processed by microcontroller 120.

Management authority switching can be implemented by triggering the power button of the multimedia player, however, when central processing unit 110 cannot be disconnected using the power button due to system errors, such that preset operations, such as accessing schedule records, cannot be normally performed. When the described errors occur the multimedia player must be disconnected

Thus, the invention provides an auto recovery method, enabling a multimedia player to be automatically recovered.

### BRIEF SUMMARY OF THE INVENTION

Auto recovery methods are provided. An exemplary embodiment of an auto recovery method comprises the following. A microcontroller is initialized and a central processing unit (CPU) is activated. It is determined whether a power-off request from the CPU is received. If not, it is determined whether a monitor message from a monitor application is periodically received. If no monitor messages are received within a predetermined period time, the CPU is disconnected and then reactivated.

Multimedia players are provided. An exemplary embodiment of a multimedia player comprises a central processing unit, a monitor application, and a microcontroller. The central processing unit sends a power-off request. The monitor application transmits a monitor message. The microcontroller is initialized based on a power signal and activates the central processing unit. It is then determined if the power-off request from the central processing unit is received. If the power-off request is not received, the microcontroller determines whether the monitor message from the monitor application is periodically received. If no monitor messages are received within a predetermined period of time, the microcontroller is disconnected and the central processing unit is reactivated.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of a multimedia player; and

FIG. 2 is a flowchart of an embodiment of an auto recovery method.

### DETAILED DESCRIPTION OF THE INVENTION

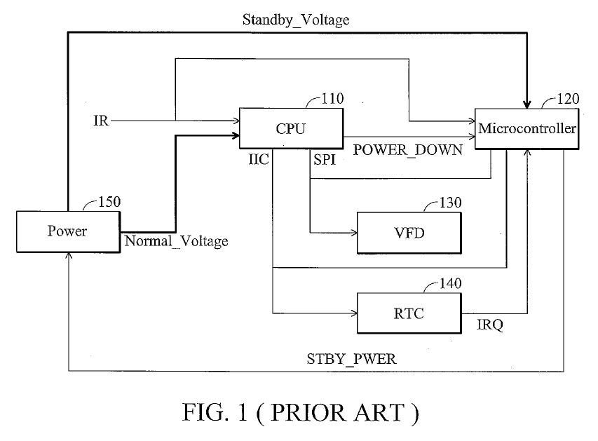

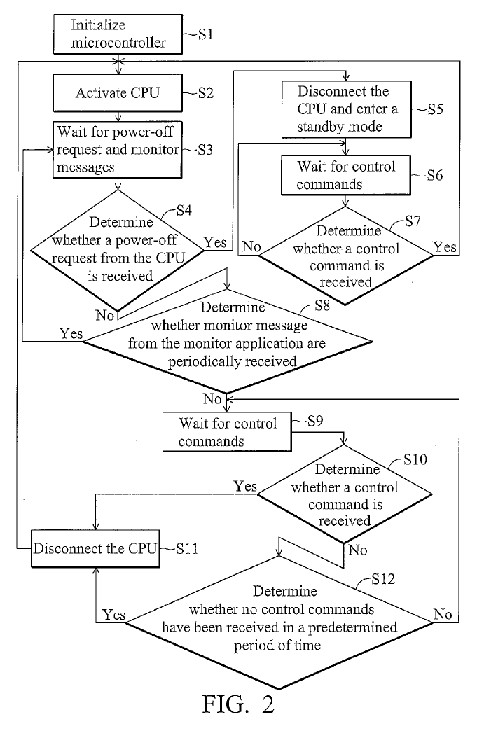

Several exemplary embodiments of the invention are described with reference to FIGS. 1 through 2, which generally relate to an auto recovery method for a multimedia player. It is to be understood that the following disclosure provides various different embodiments as examples for implementing different features of the invention. Specific examples of components and arrangements are described in the following to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various described embodiments and/or configurations.

The invention discloses an auto recovery method for a multimedia player.

FIG. 2 is a flowchart of an embodiment of an auto recovery method.

Referring to FIG. 1, when a multimedia player is powered on, microcontroller 120 is first initialized (step S1) and microcontroller 120 activates CPU 110 (indicating the main power of the multimedia player is powered on) (step S2). Currently, microcontroller 120 waits for a power-off request from CPU 110 and monitors messages periodically transmitted from a monitor application (Watchdog) (not shown) to microcontroller 120 while CPU 110 operates normally (step S3). If CPU 110 is provided with preset operations, such as schedule records, or other operations, the multimedia player is always managed by CPU 110.

Next, microcontroller 120 determines whether a power-off request from CPU 110 is received (step S4). If CPU 110 is idle within a predetermined period of time, a power-off request is sent to microcontroller 120, and, upon receiving the power-off request, microcontroller 120 disconnects CPU 120 (indicating the main power of the multimedia player is powered off), such that the multimedia player enters a standby mode (step S5). In the standby mode, microcontroller 120 may receive control commands generated by pressing a button on VFD 130 located at a front panel (not shown) or on a remote controller (not shown), the power button, or the tray out button. Microcontroller 120 may also receive an IRQ, generated while the time of a schedule record is reached, from RTC 140 (step S6). Microcontroller 120 determines whether the control command is received (step S7). Since CPU 110 is currently disconnected, when receiving the control command, microcontroller 120 must reactivate CPU 110 (indicating the main power of the multimedia player is active) to perform corresponding operations (step S2). If the control command is not received, microcontroller 120 continues to wait for control commands or IRQs (step S6).

As described, when CPU 110 governs the management authority of the multimedia player, microcontroller 120 continues to wait continues to wait for power-off requests from CPU 110 and monitors for messages periodically transmitted from the monitor application (Watchdog) (not shown) while CPU 110 operates normally. If microcontroller 120 does not receive any power-off requests from CPU 110, microcontroller 120 determines whether monitor messages from the monitor application are periodically received (step S8). If so, microcontroller 120 continues to wait for power-off requests from CPU 110 and monitor messages periodically transmitted from the monitor application (Watchdog) (not shown) while CPU 110 normally works (step S3). If no monitor messages are received within a predetermined period of time, indicating CPU 110 is processing abnormal operations or system abnormalities are detected, microcontroller 120 waits for control commands or IRQs described in step S6 (step S9).

Microcontroller 120 determines whether a control command is received (step S10). If the control command is received, microcontroller 120 actively disconnects CPU 110 (indicating the main power of the multimedia player not active) (step S11) and then reactivates CPU 110 (step S2). If the control command is not received, microcontroller 120 determines whether no control commands have been received within a predetermined period of time (step S12). If not, the process proceeds to step S9. If so, microcontroller 120 actively disconnects CPU 110 (step S11) and then reactivates CPU 110 (step S2).

The monitor application (Watchdog) (not shown) is programmed and installed in CPU 110 to periodically monitor operational states of CPU 110. Additionally, an embodiment of the multimedia player provides, but is not limited to, CPU 110, microcontroller 120, VFD 130, and RTC 140. RTC 140, for example, can be installed in microcontroller 120.

In an embodiment of the method when system errors are detected, a CPU of a multimedia player is deactivated using a microcontroller based on a monitor application and then reactivated.

Methods and systems of the present disclosure, or certain aspects or portions of embodiments thereof, may take the form of program code (i.e., instructions) embodied in media, such as floppy diskettes, CD-ROMS, hard drives, firmware, or any other machine-readable storage medium, wherein, when the program code is loaded into and executed by a machine, such as a computer, the machine becomes an apparatus for practicing embodiments of the disclosure. The methods and apparatus of the present disclosure may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing and embodiment of the disclosure. When implemented on a general-purpose processor, the program code combines with the processor to provide a unique apparatus that operates analogously to specific logic circuits.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An auto recovery method, comprising:
initializing a microcontroller;
activating a central processing unit;
determining whether a power-off request from the central processing unit is received;
if the power-off request is not received, determining whether a monitor message from a monitor application is periodically received;
if no monitor messages are received within a predetermined period of time, disconnecting and then reactivating the central processing unit.

2. The auto recovery method as claimed in claim 1, further comprising:
if the duration of not periodically receiving the monitor message exceeds the predetermined time, determining whether a control command is received; and
disconnecting and then reactivating the central processing unit if the control command is received.

3. The auto recovery method as claimed in claim 2, further comprising:
the microcontroller disconnecting the central processing unit if the power-off request from the central processing unit is received;
the microcontroller determining whether the control command is received; and
the microcontroller reactivates the central processing unit if the control command is received.

4. The auto recovery method as claimed in claim 1, further comprising disconnecting and then reactivating the central processing unit using the microcontroller.

5. The auto recovery method as claimed in claim 4, further comprising generating the control command by pressing a button on a vacuum fluorescent display (VFD) of a front panel or on a remote controller or implementing a preset operation.

6. The auto recovery method as claimed in claim 1, further comprising programming and installing the monitor application in the central processing unit.

7. A multimedia player, comprising:
a central processing unit, for sending a power-off request;
a monitor application, for transmitting a monitor message; and
a microcontroller, being initialized and activating the central processing unit based on a power signal;
wherein the microcontroller determines whether the power-off request from the central processing unit is received, and determines whether the monitor message from the monitor application is periodically received if the power-off request is not received, and disconnects and reactivates the central processing unit if no monitor message is received within a predetermined period of time.

8. The multimedia player as claimed in claim 7, further comprising a controller for generating a control command, wherein when the monitor message is not received by the microcontroller within the predetermined period of time, the microcontroller determines whether the control command is received, and if the control command is received, the microcontroller disconnects and then reactivates the central processing unit.

9. The multimedia player as claimed in claim 8, wherein the controller is a vacuum fluorescent display (VFD) of a front panel, a remote controller, or a real-time clock (RTC).

10. The multimedia player as claimed in claim 7, wherein the microcontroller disconnects the central processing unit if the power-off request from the central processing unit is received, and reactivates the central processing unit when the control command is received.

11. The multimedia player as claimed in claim 7, wherein the monitor application is programmed and installed in the central processing unit.

12. A computer-readable storage medium storing a computer program providing an auto recovery method, comprising using a computer to perform the steps of:
initializing a microcontroller;
activating a central processing unit;
determining whether a power-off request from the central processing unit is received;
if the power-off request is not received, determining whether a monitor message from a monitor application is periodically received; and
if a duration during which the monitor message is not periodically received exceeds a predetermined time, disconnecting and then reactivating the central processing unit.

13. The computer-readable storage medium as claimed in claim 12, further comprising:
if the duration during which the monitor message is not periodically received exceeds the predetermined time, determining whether a control command is received; and
if the control command is received, disconnecting and then reactivating the central processing unit.

14. The computer-readable storage medium as claimed in claim 12, further comprising disconnecting and then reactivating the central processing unit using the microcontroller.

15. The computer-readable storage medium as claimed in claim 12, further comprising:
if the power-off request from the central processing unit is received, the microcontroller disconnecting the central processing unit;
the microcontroller determining whether the control command is received; and
if the control command is received, the microcontroller reactivating the central processing unit.
